(19) United States
(12) Patent Application Publication
(10) Pub. No.: US 2005/0248899 A1
(43) Pub. Date: Nov. 10, 2005

(54) Power strip having the function of neutral line switching

(76) Inventor: Cheng-Yuan Huang, Hsintien City (TW)

Correspondence Address: PRO-TECHTOR INTERNATIONAL, 20775 Norada Court, Saratoga, CA, 95070-3018, US

(21) Appl. No.: 10/961,650

(22) Filed: Oct. 8, 2004

(30) Foreign Application Priority Data
May 7, 2004 (TW) 93207165

(51) Int. Cl. H02H 9/06

(52) U.S. Cl. 361/118

(57) ABSTRACT

A power strip is described. The power strip is connected to a hot line and a neutral line of a power source via a plug. The power strip has at least a light-emitting device, a protection device, and a switch. The light-emitting device is connected to a test point at one terminal and connected to one terminal of a resister at another terminal. The protection device is connected to the test point at a terminal and connected to a ground-conducting strip at the other terminal. When the switch is switched to a first position, the hot line is connected to the test point. When the switch is switched to a second position, the neutral line is connected to the test point. Therefore, without pulling out and inserting the plug again, the power strip switches the neutral line to the ground-conducting strip.

### RELATED APPLICATIONS

The present application is based on, and claims priority from, Taiwan Application Serial Number 93207165, filed May 7, 2004, the disclosure of which is hereby incorporated by reference herein in its entirety.

### BACKGROUND

1. Field of Invention

The present invention relates to a power strip. More particularly, the present invention relates to a power strip that can allow a user to detect the hot line and the neutral line and to switch the ground-conducting strip to the neutral line.

2. Description of Related Art

A traditional power strip has a three-hole outlet design to accommodate electric appliances having a ground prong. For example, the plug of a display or a computer usually has a ground prong. The ground prong can eliminate leakage current and electromagnetic radiation. The ground prong can also prevent a user from inserting the plug into the outlet in reverse.

However, in many cases, a conventional wall outlet only provides two holes. Therefore, the three-pin plug cannot be inserted into the conventional wall outlet. The ground prong may be removed to make the plug fit into the conventional, two-hole outlet. The ground prong then loses its function. Additionally, a user may insert the plug into the outlet in reverse so that the leakage current and electromagnetic wave are generated.

### SUMMARY

It is therefore an objective of the present invention to provide a power strip, in which a user can detect the connection of the hot line and the neutral line without re-inserting a plug.

It is another objective of the present invention to provide a power strip, in which the induction current and the leakage current generated by an electric appliance are guided to the neutral line of a conventional wall outlet to avoid a health hazard and to prevent the user from getting an electric shock.

It is still another objective of the present invention to provide a power strip, in which the ground-conducting strip of the power strip is correctly grounded by a simple switch action.

In accordance with the foregoing and other objectives of the present invention, a power strip is described. According to a preferred embodiment of the invention, the power strip is used to connect to the hot line and the neutral line of a conventional wall outlet through a plug. The power strip includes a light-emitting device, a protection device, and a switch. The light-emitting device is connected to a test point at a terminal of the light-emitting device. The light-emitting device is connected to a terminal of a resistor at the other terminal of the light-emitting device. The protection device is connected to the test point at a terminal of the protection device. The protection device is connected to a ground-conducting strip at the other terminal of the protection device. The protection device prevents power surges and prevents the passage of an instant large amount of current. When the switch is switched to a first position, the switch connects the hot line to the test point. When the switch is switched to a second position, the switch connects the neutral line to the test point. Thus, without re-inserting the plug to the conventional wall outlet, the power strip is capable of switching the neutral line to the right position by the switch.

The switch is, for example, a slide switch. The protection device is, for example, a fuse, a low resistance resistor, or a PPTC (polymeric positive temperature coefficient) reset device. The light emitter is, for example, a Ne light source. The resistor, the light-emitting device, and the switch can be used in any kind of electric appliance to test the hot line and the neutral line.

The invention has at least the following advantages. Because a switch is used in the invention, a user can detect the connection of the hot line and the neutral line without re-inserting a plug. Judging from whether the light-emitting device is illuminated, the user switches the switch between the two positions to provide a correct connection among the hot line, the neutral line, and the ground-conducting strip. When there exists a fault in indoor distribution, the invention is able to discover the fault. When the light-emitting device is illuminated, the user only needs to switch to the other position to make sure the connection is correct. The ground-conducting strip is then correctly connected to the neutral line of the conventional wall outlet. The electric appliance using the power strip need not be turned off and no re-inserting of the plug is needed. As a result, the induction current and the leakage current generated by an electric appliance are guided to the neutral line of a conventional wall outlet to avoid a health hazard and to prevent the user from getting an electric shock.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating a preferred embodiment of the power strip according to the invention; and

FIG. 2 is a perspective diagram of an example of the preferred embodiment of FIG. 1.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

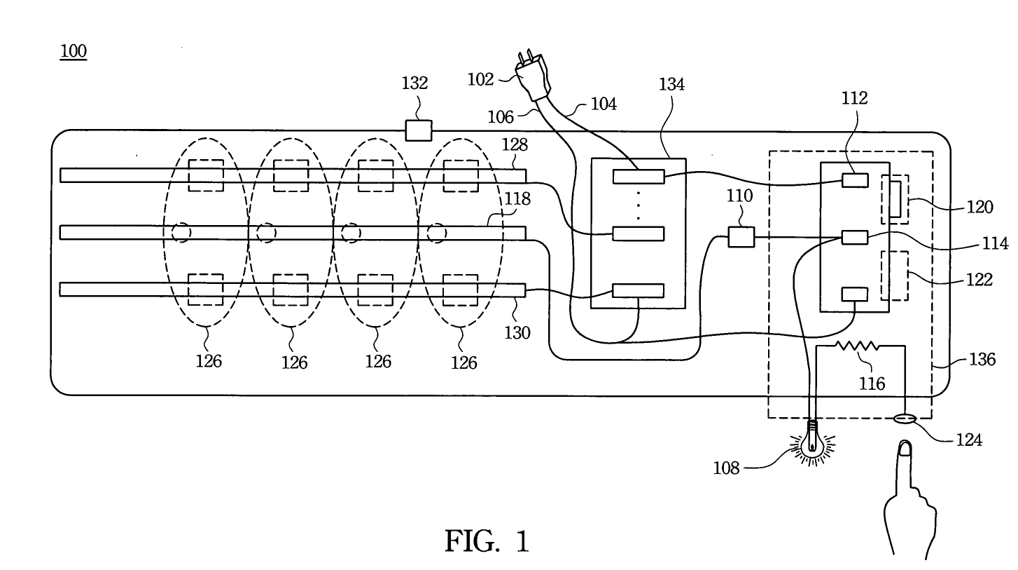

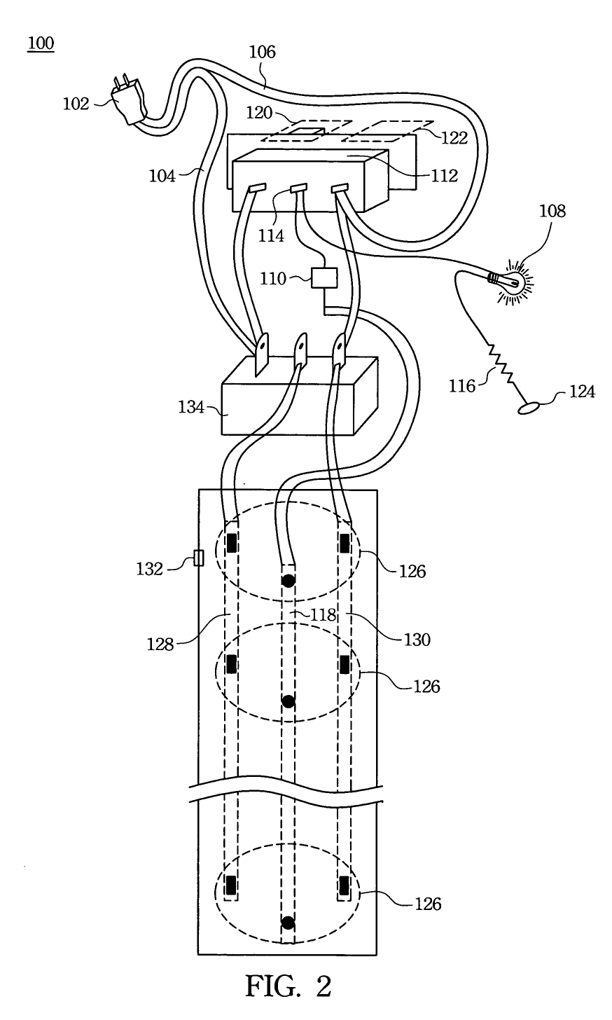

FIG. 1 is a diagram illustrating a preferred embodiment of the power strip according to the invention. FIG. 2 is a perspective diagram of an example of the preferred embodiment of FIG. 1. With reference to FIG. 1 and FIG. 2, the power strip 100 is connected to the hot line 104 and the neutral line 106 of a conventional wall outlet through a plug 102. The power strip 100 includes a light-emitting device 108, a protection device 110, and a switch 112.

The light-emitting device 108 is connected to a test point 114 at a terminal of the light-emitting device 108. The light-emitting device 108 is connected to a terminal of a resistor 116 at the other terminal of the light-emitting device 108. The protection device 110 is connected to the test point 114 at one terminal and connected to a ground-conducting strip 118 at another terminal. The protection device 110 prevents power surges and prevents the passage of an instant large amount of current. When the switch 112 is switched to a first position 120, the switch 112 connects the hot line 104 to the test point 114. When the switch 112 is switched to a second position 122, the switch 112 connects the neutral line 106 to the test point 114. Thus, without re-inserting the plug 102 into the conventional wall outlet, the power strip 100 utilizes the switch 112 to switch between the hot line 104 and the neutral line 106 for testing. The power strip 100 is also capable of correctly connecting the ground-conducting strip 118 to the neutral line 106 by the switch 112.

When the switch 112 is switched to the first position 120, the hot line 104 is electrically connected to the test point 114. A user can use his finger to touch a terminal 124 of the resistor 116 and then the light-emitting device 108 is illuminated. When the switch 112 is switched to the second position 122, the neutral line 106 is electrically connected to the test point 114. A user can use his finger to touch a terminal 124 of the resistor 116 and then the light-emitting device is not illuminated. Thus, the light-emitting device 108 can be used to detect the hot line 104 and the neutral line 106.

When the plug 102 has already been inserted in the outlet, the user doesn't have to pull the plug 102 out of the outlet, reverse the two pins of the plug 102, and re-insert the plug 102 into the outlet to achieve the object of switching the hot line 104 and the neutral line 106. The user only needs to switch the switch 112 to achieve the object of switching the hot line 104 and the neutral line 106. The light-emitting device 108 is used to detect whether the neutral line 106 is connected to the right position (the ground-conducting strip 118). When the user finds that the light-emitting device is illuminated, the user only has to switch the switch 112 to turn the light-emitting device off. The neutral line 106 is naturally connected to the ground-conducting strip 118 and the step of re-inserting the plug 102 is not necessary. The electric appliances attached to the power strip don't need to be turned off when switching the switch 112. User convenience is greatly increased.

The switch 112 is, for example, a slide switch, as shown in FIG. 1. The power strip 100 has a plurality of three-hole outlets 126. The power strip 100 contains a hot line conducting strip 128 and a neutral line conducting strip 130. The hot line conducting strip 128, the neutral line conducting strip 130, and the ground line conducting strip 118 match the three-hole outlets 126. A grounding point 132 is located beside each outlet 126. The grounding points 132 are used for an electric appliance having a ground contact.

The protection device 110 is, for example, a fuse, a low resistance resistor or a PPTC (polymeric positive temperature coefficient) reset device. The protection device 110 prevents power surges and prevents the passage of an instant large amount of current. The light-emitting device is, for example, a Ne light source.

The power strip 100 can include an overload protection switch 134. The overload protection switch 134 is connected to the hot line 104 at a terminal and connected to the hot line conducting strip 128 at another terminal. When the current passing through the overload protection switch 134 is overly large, the overload protection switch 134 automatically turns off the connection between the hot line 104 and the hot line conducting strip 128.

When the plug is inserted into the outlet with a reversed pin arrangement, the hot line 104 and the neutral line 106 (shown in FIG. 1) are exchanged, but the function of the switch 112 is not affected. The switch 112 can still switch between the hot line 104 and the neutral line 106. At this time, the overload protection switch 134 is connected to the neutral line 104 (the original hot line 104) at a terminal and connected to the neutral line conducting strip 128 (the original hot line conducting strip 128) at another terminal. When the current passing through the overload protection switch 134 is overly large, the overload protection switch 134 automatically turns off the connection between the neutral line 104 and the neutral line conducting strip 128.

In FIG. 1, the neutral line switching apparatus 136 includes the resistor 116, the light-emitting device 108, and the switch 112. The neutral line switching apparatus 136 is not limited to use in a power strip. The neutral line switching apparatus 136 can also be used in any kind of electric appliance to detect the hot line and the neutral line and to ground the electric appliance correctly.

The invention has at least the following advantages. With reference to FIG. 1 and FIG. 2, because a switch 112 is used in the invention, a user can detect the connection of the hot line 104 and the neutral line 106 without re-inserting a plug. The connection information of the hot line 104 and the neutral line 106 can be obtained from the illumination status of the light-emitting device 108.

Judging from whether the light-emitting device 108 is illuminated, the user switches the switch 112 between the two positions to provide a correct connection among the hot line 104, the neutral line 106, and the ground-conducting strip 118. The electric appliances attached to the plug don't have to be turned off when the switch 112 is switched.

When the light-emitting device 108 is illuminated, the user only needs to switch to the other position to make sure the connection is correct. The ground-conducting strip 118 is then correctly connected to the neutral line 106 of the conventional wall outlet. No re-insertion of the plug 102 is necessary. As a result, the induction current and the leakage current generated by an electric appliance are guided to the neutral line 106 of a conventional wall outlet to avoid a health hazard and to prevent the user from getting an electric shock.

Although the present invention has been described in considerable detail with reference to certain preferred embodiments thereof, other embodiments are possible. Therefore, their spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A power strip used to connect to the hot line and the neutral line of a conventional wall outlet through a plug, the power strip comprising:
a light-emitting device, connected to a test point at a terminal of the light-emitting device, the light-emitting device connected to a terminal of a resistor at another terminal of the light-emitting device;
a protection device, connected to the test point at a terminal of the protection device, the protection device connected to a ground-conducting strip at another terminal of the protection device, the protection device preventing power surges and preventing passage of an instant large amount of current; and
a switch, wherein when the switch is switched to a first position, the switch connects the hot line to the test point, and when the switch is switched to a second position, the switch connects the neutral line to the test point;
wherein without re-inserting the plug into the conventional wall outlet, the power strip is capable of switching the neutral line to a correct position by the switch.

2. The power strip of claim 1, wherein the switch is a slide switch.

3. The power strip of claim 1, wherein the protection device is a fuse.

4. The power strip of claim 1, wherein the protection device is a low resistance resistor.

5. The power strip of claim 1, wherein the protection device is a PPTC reset device.

6. The power strip of claim 1, wherein the light emitter is a Ne light source.

7. The power strip of claim 1, wherein the power strip has a plurality of three-hole outlets, the power strip further comprises a hot line conducting strip and a neutral line conducting strip, the hot line conducting strip, the neutral line conducting strip, and the ground-conducting strip match the three-hole outlets, a grounding point is located beside each outlet, and the grounding points are used for an electric appliance having a ground contact.

8. The power strip of claim 1, further comprising an overload protection switch, wherein the overload protection switch is connected to the hot line at a terminal and connected to the hot line conducting strip at another terminal, and when current passing through the overload protection switch is overly large, the overload protection switch automatically turns off a connection between the hot line and the hot line conducting strip.

9. The power strip of claim 1, further comprising an overload protection switch, wherein the overload protection switch is connected to the neutral line at a terminal and connected to the neutral line conducting strip at another terminal, and when current passing through the overload protection switch is overly large, the overload protection switch automatically turns off a connection between the neutral line and the neutral line conducting strip.

10. A power strip used to connect to the hot line and the neutral line of a conventional wall outlet through a plug, the power strip comprising:
a resistor;
a light-emitting device, connected to a test point at a terminal of the light-emitting device, the light-emitting device connected to a terminal of the resistor at another terminal of the light-emitting device; and
a switch, wherein when the switch is switched to a first position, the switch connects the hot line to the test point, and when the switch is switched to a second position, the switch connects the neutral line to the test point;
wherein without re-inserting the plug into the conventional wall outlet, the power strip is capable of switching the neutral line to a correct position by the switch.

11. The power strip of claim 10, further comprising a protection device connected to the test point at a terminal of the protection device, the protection device connected to a ground-conducting strip at another terminal of the protection device, the protection device preventing power surges and preventing passage of an instant large amount of current.

12. The power strip of claim 11, wherein the protection device is a fuse.

13. The power strip of claim 11, wherein the protection device is a low resistance resistor.

14. The power strip of claim 11, wherein the protection device is a PPTC reset device.

15. The power strip of claim 10, wherein the switch is a slide switch.

16. The power strip of claim 10, wherein the light emitter is a Ne light source.

17. The power strip of claim 10, wherein the power strip has a plurality of three-hole outlets, the power strip further comprises a hot line conducting strip and a neutral line conducting strip, and the ground-conducting strip, the hot line conducting strip, the neutral line conducting strip, and the ground-conducting strip match the three-hole outlets, a grounding point is located beside each outlet, and the grounding points are used for an electric appliance having a ground contact.

18. The power strip of claim 10, further comprising an overload protection switch, wherein the overload protection switch is connected to the hot line at a terminal and connected to the hot line conducting strip at another terminal, and when current passing through the overload protection switch is overly large, the overload protection switch automatically turns off a connection between the hot line and the hot line conducting strip.

19. The power strip of claim 10, further comprising an overload protection switch, wherein the overload protection switch is connected to the neutral line at a terminal and connected to the neutral line conducting strip at another terminal, and when current passing through the overload protection switch is overly large, the overload protection switch automatically turns off a connection between the neutral line and the neutral line conducting strip.

20. A neutral line switching apparatus used to connect to the hot line and the neutral line of a conventional wall outlet through a plug, the neutral line switching apparatus comprising:
a resistor;
a light-emitting device, connected to a test point at a terminal of the light-emitting device, the light-emitting device connected to a terminal of the resistor at another terminal of the light-emitting device; and
a switch, wherein when the switch is switched to a first position, the switch connects the hot line to the test point, and when the switch is switched to a second position, the switch connects the neutral line to the test point;
wherein without re-inserting the plug to the conventional wall outlet, the power strip is capable of switching the neutral line to a correct position by the switch.

21. The neutral line switching apparatus of claim 20, wherein the neutral line switching apparatus is installed in an electric appliance.
